(19) United States
(12) Patent Application Publication
(10) Pub. No.: US 2020/0151712 A1
(43) Pub. Date: May 14, 2020

(54) SYSTEM AND METHOD FOR SMART CONTRACTS

(71) Applicant: The Trustees of Princeton University, Princeton, NJ (US)

(72) Inventors: Edward W. Felten, Princeton, NJ (US); Steven Goldfeder, Spring Valley, NY (US); Harry Kalodner, Princeton, NJ (US)

(73) Assignee: The Trustees of Princeton University, Princeton, NJ (US)

(21) Appl. No.: 16/561,612

(22) Filed: Sep. 5, 2019

Related U.S. Application Data
(60) Provisional application No. 62/757,250, filed on Nov. 8, 2018.

(51) Int. Cl. G06Q 20/38; G06F 9/455; H04L 9/32

(52) U.S. Cl. CPC G06Q 20/389; G06Q 20/3827; G06Q 20/3825; G06F 2009/45562; H04L 9/3236; H04L 9/3247; G06Q 2220/00; G06F 9/45558

(57) ABSTRACT

Disclosed is a cryptocurrency system (“Arbitrum”) that supports smart contracts without the scalability and privacy limitations of previous systems such as Ethereum. Arbitrum, like Ethereum, allows parties to create smart contracts by using code to specify the behavior of a virtual machine (VM) that implements the contract's functionality. Arbitrum uses mechanism design to incentivize parties to agree off-chain on what a VM would do, so that the Arbitrum verifiers need only verify digital signatures to confirm that parties have agreed on a VM's behavior. In the event that the parties cannot reach unanimous agreement off-chain, Arbitrum still allows honest parties to advance the VM state on-chain. If a party tries to lie about a VM's behavior, the verifier (or miners) will identify and penalize the dishonest party by using a highly efficient challenge-based protocol that exploits features of the Arbitrum virtual machine architecture. Moving the verification of VMs' behavior off-chain in this way provides dramatic improvements in scalability and privacy.

### CROSS-REFERENCE TO RELATED APPLICATIONS

This application claims priority to U.S. Provisional Application No. 62/757,250 filed Nov. 8, 2018, which is hereby incorporated in its entirety by reference.

### STATEMENT REGARDING FEDERALLY SPONSORED RESEARCH OR DEVELOPMENT

This invention was made with government support under Grant Nos. DGE-1148900 and CNS-1651938 awarded by the National Science Foundation. The government has certain rights in the invention.

### BACKGROUND

The combination of digital currencies and smart contracts is a natural marriage. Cryptocurrencies allow parties to transfer digital currency directly, relying on distributed protocols, cryptography, and incentives to enforce basic rules. Smart contracts allow parties to create virtual trusted third parties that will behave according to arbitrary agreed-upon rules, allowing the creation of complex multi-way protocols with very low counterparty risk. By running smart contracts on top of a cryptocurrency, one can encode monetary conditions and penalties inside the contract, and these will be enforced by the underlying consensus mechanism.

Ethereum was the first cryptocurrency to support Turing-complete stateful smart contracts, but it suffers from limits on scalability and privacy. Ethereum requires every miner to emulate every step of execution of every contract, which is expensive and severely limits scalability. It also requires the code and data of every contract to be public, absent some type of privacy overlay feature which would impose costs of its own.

Thus, a system and method that avoids these shortcomings is desirable.

### BRIEF SUMMARY

Disclosed is a method for implementing more efficient, scalable, private smart contracts. The method requires first creating a virtual machine (VM) that specifies an initial hash of the VM's state, a list of validators for the VM, and a length of a challenge period, where the hash of the VM's state represents a cryptographic commitment to the VM's code and initial data. The method then requires tracking, with a verifier, only a hash of the VM's current state, currency held by the VM, and a hash of the VM's inbox which holds messages sent to the VM. At least one validator is then allowed to sign an assertion about the VM's execution. The assertion should specify how many instructions are to be executed by the VM, a hash of the VM's state after execution, and a set of preconditions that includes the hash of the VM's state before the execution as well as a hash of the VM's inbox. The signature of the validators that sign must then be verified. Finally, the method requires determining if the signed assertion is eligible, where a signed assertion is only eligible if the signed assertion's preconditions match the current state of the VM (which may include, e.g., a state of the external world, such as the current time), the VM is not in a halted state, and the VM has enough funds to make any payment specified by the signed assertion.

Optionally, the method may also include deeming the VM to have made the asserted state change and taken the asserted actions of a signed assertion if the signatures of each of a plurality of validators are verified.

Optionally, the method may also include publishing an eligible signed assertion as pending if not all of the plurality of validators signs the signed assertion; having the asserting validator escrow a deposit; and entering into the challenge period. In some embodiments, the asserting validator may get its deposit back if no challenge occurs during the challenge period. In some embodiments, the method also includes having a validator challenge the asserting validator's signed assertion during the challenge period by escrowing a deposit and participating in a protocol based on recursive division of the signed assertion that is refereed by the verifier. In some embodiments, the verifier only checks the facial validity of actions performed during the protocol. In some embodiments, if a first party is deemed the winner of the protocol and a second party is deemed the loser of the protocol, the winner of the protocol may recovers its own deposit and a portion of the losing party's deposit, and the loser of the protocol loses its deposit.

Optionally, the method may also have each validator escrows an initial deposit when a new VM is created, where the initial deposit is deemed to cover each of that validator's assertions and challenges over the life of the new VM.

Optionally, creating the VM further includes specifies at least one additional parameter, such as an amount of a payment or deposit that a party will make as the protocol executes further.

Optionally, the assertion may also include an action to be taken by the VM, such as making a payment.

Also disclosed is a system configured for implementing more efficient, scalable, private smart contracts. The system includes one or more processors configured by machine-readable instructions in a way that utilizes the method described above, including instructions that first create a virtual machine (VM) that specifies an initial hash of the VM's state, a list containing a plurality of validators for the VM, and a length of a challenge period, where the hash of the VM's state represents a cryptographic commitment to the VM's code and initial data. The instructions also cause one or more processors to track, with a verifier, only a hash of the VM's current state, currency held by the VM, and a hash of the VM's inbox which holds messages sent to the VM, and to receive a signed assertion about the VM's execution from a validator, the signed assertion specifying how many instructions are to be executed by the VM, a hash of the VM's state after execution, and a set of preconditions that includes the hash of the VM's state before the execution, and a hash of the VM's inbox. The instructions also cause one or more processors to verify the signature of the validators that signed the assertion. The instructions also cause one or more processors to determine if the signed assertion is eligible, where a signed assertion is only eligible if the signed assertion's preconditions match the current state of the VM, the VM is not in a halted state, and the VM has enough funds to make any payment specified by the signed assertion. The system then deems the VM to have made the asserted state change and taken the asserted actions of an eligible signed assertion if each of the signatures of the plurality of validators are verified, and publishes the eligible signed assertion as pending if not all of the plurality of validators signs the signed assertion, enter into a challenge period, and require the asserting validator escrow a deposit. The system then sends the asserting validator its deposit back if no challenge occurs during the challenge period and deem the VM to have made the asserted state change and taken the asserted actions of an eligible signed assertion if the signatures of the at least one validator's signature are verified. The system also receives a deposit from a challenging validator, verify the facial validity of actions performed during a protocol based on recursive division of the signed assertion, determines a first party to be the winner of the protocol and a second party to be the loser of the protocol, and sends the winner of the game its own deposit and a portion of the losing party's deposit.

Optionally, the instructions to verify the facial validity of actions can includes instructions to receive a plurality of small assertions and verify that the plurality of small assertions combine to yield the signed assertion.

Optionally, creating the VM further includes specifies at least one additional parameter, such as an amount of a payment or deposit that a party will make as the protocol executes further.

Optionally, the assertion may also include an action to be taken by the VM, such as making a payment.

Also disclosed is a non-transitory computer readable medium storing software for handling proofs efficiently, where the software includes executable code that creates a virtual machine associated with a data storage.

In some embodiments, the virtual machine is configured to have memory organized as a set of blocks having a fixed upper size limit, and further configured to allow blocks to reference other blocks only in an acyclic fashion. Optionally, the blocks may be immutable. Optionally, the virtual machine may also be configured to emit a proof that is checkable by some external party.

In other embodiments, the virtual machine is configured to have instructions organized using a stack data structure whereby each instruction is removed from stack when executed. Optionally, the virtual machine is also configured to replace a stack of instructions with a new stack of instructions, save values to the data storage, restore values from the data storage, or some combination thereof. Optionally, the virtual machine may also configured to emit a proof that is checkable by some external party.

Also disclosed is a virtual machine (VM) that includes one or more processors configured by machine-readable instructions to store an initial hash of the VM's state, store a list of validators for the VM, and store a length of a challenge period. The hash of the VM's state represents a cryptographic commitment to the VM's code and initial data. The one or more processors also send a signal comprising a hash of the VM's current state, currency held by the VM, and a hash of the VM's inbox which holds messages sent to the VM. The one or more processors also receive a signed assertion about the VM's execution from a validator, the signed assertion specifying how many instructions are to be executed by the VM, a hash of the VM's state after execution, and a set of preconditions that includes the hash of the VM's state before the execution, and a hash of the VM's inbox.

Also disclosed is a verifier. The verifier includes one or more processors configured by machine-readable instructions to track the hash of a state of a virtual machine (VM), employ a bisection protocol to narrow a disagreement about what the VM will do to an execution of a single instruction, receive a proof of the execution of a single instruction, and verify the proof.

### BRIEF DESCRIPTION OF THE DRAWINGS

FIG. 1 is a schematic overview of the state machine that governs the status of each VM in the disclosed protocol.

FIG. 2 is a schematic illustrating information revealed in a one-step proof of an add instruction. Circles represent value hashes and inner square boxes represent the values themselves. Black boxes are values that are sent by the asserter to the verifier in the one-step proof.

FIG. 3 is a flowchart illustrating one embodiment of the disclosed method.

### DETAILED DESCRIPTION

Disclosed is a new approach to smart contracts which addresses the shortcomings of previous smart contracts. The disclosed contracts are very cheap for verifiers to manage. As used herein, the term “verifiers” generically refers to the underlying consensus mechanism. For example, in the Bitcoin protocol, Bitcoin miners are the verifiers. If parties behave according to incentives, verifiers in the disclosed system need only verify a few digital signatures for each contract. Even if parties behave counter to their incentives, verifiers in the disclosed system can efficiently adjudicate disputes about contract behavior without needing to examine the execution of more than one instruction by the contract. The disclosed system and method also allow contracts to execute privately, publishing only (saltable) hashes of contract states.

In the disclosed system and method, parties can implement a smart contract as a Virtual Machine (VM) that encodes the rules of a contract. The creator of a VM designates a set of validators for the VM. The disclosed protocol provides an any-trust guarantee: any one honest validator can force the VM to behave according to the VM's code. The parties that are interested in the VM's outcome can themselves serve as validators or appoint someone they trust to manage the VM on their behalf. For many contracts, the natural set of validators will be quite small in practice.

Relying on validators, rather than requiring every verifier to emulate every VM's execution, allows a VM's validators to advance the VM's state at a much lower cost to the verifiers. Verifiers track only the hash of the VM's state, rather than the full state. The disclosed system and method create incentives for the validators to agree out-of-band on what the VM will do. Any state change that is endorsed by all of the validators (and does not overspend the VM's funds) will be accepted by the verifiers. If, contrary to incentives, two validators disagree about what the VM will do, the verifiers employ a dissection protocol (such as a bisection protocol) to narrow the disagreement down to the execution of a single instruction, and then one validator submits a simple proof of that one-instruction execution which the verifiers can check very efficiently. The validator who was wrong pays a substantial financial penalty to the verifiers, which serves to deter disagreements.

Parties can send messages and currency to a VM, and a VM can itself send messages and currency to other VMs or other parties. VMs may take actions based on the messages they receive. The Verifier tracks the hash of the VM's inbox.

The architecture of the disclosed VM and protocol are designed to make the task of resolving disputes as fast and simple for the verifiers as possible.

The disclosed approach dramatically reduces the cost of smart contracts. If participants behave according to their incentives, then verifiers will never have to emulate or verify the behavior of any VM. The only responsibility of verifiers in this case is to do simple bookkeeping to track the currency holdings, the hash of a message inbox, and a single hashed state value for each VM. If a participant behaves irrationally, it may require the verifiers to do a modest amount of extra work, but the verifiers will be (over-)compensated for this work at the expense of the irrational party.

As a corollary of the previous principle, the disclosed VMs can be private, in the sense that a VM can be created and execute to completion without revealing the VM's code or its execution except for the content and timing of the messages and payments it sends, and (saltable) hashes of its state. Any validator of a VM will necessarily have the ability to reveal information about that VM, but if validators want to maintain a VM's privacy they can do so.

The disclosed approach is consensus-agnostic, meaning that it assumes the existence of a consensus mechanism that publishes transactions, but the disclosed design works equally well with any consensus mechanism, including a single centralized publisher, a quorum-based consensus system, or Nakamoto consensus as used in Bitcoin. Additionally, an existing smart contract system can serve as this consensus mechanism assuming it can encode the disclosed system's rules as a smart contract.

As used herein, the consensus entity or system is referred to as the “Verifier” and the participants in the said consensus system are referred to as the “verifiers”.

Roles.

There are four types of roles in the disclosed protocol and system.

1. A key is a participant in the protocol that can own currency and propose transactions. A key is identified by (the hash of) a public key. It can propose transactions by signing them with the corresponding private key.

2. A VM (Virtual Machine) is a virtual participant in the protocol. Every VM has code and data that define its behavior. Like keys, VMs can own currency and send and receive currency and messages. A VM is created by a special transaction type.

3. The Verifier is the global entity or distributed protocol that verifies the validity of transactions and publishes accepted transactions. The Verifier might be a central entity or a distributed multiparty consensus system such as a distributed quorum system, a worldwide collection of miners as in the Nakamoto consensus protocol, or itself a smart contract on an existing cryptocurrency. Because the disclosed design is agnostic as to which type of consensus system is used, for brevity the singular term Verifier is used for whatever consensus system is operating.

4. A validator of a VM is a party that monitors the progress of a particular VM and ensures the VM's correct behavior. When a VM is created, the transaction that creates the VM specifies a set of validators for the VM. A validator is identified by (the hash of) its public key.

The VM. The VM architecture governs the syntax and semantics of the disclosed system's programs that run within a VM. The VM has been designed with the goal of making the Verifier's task of checking one-step proofs as fast and simple as possible. In particular, the VM design guarantees that the space to represent a one-step proof and the time to generate and verify such a proof are bounded by small constants, independent of the size and contents of the program's code and data.

As an example of an architectural choice to support constant-bounded proofs, the VM does not offer a large, flat memory space. Providing an efficiently updatable hash of a large flat memory space would require the space to be hashed in Merkle Tree style, with a prover needing to provide Merkle proofs of memory state, which requires logarithmic proof space and logarithmic time to prove and verify. Instead, the VM provides a tuple data type that can store up to eight values, which can contain other tuples recursively. This allows the same type of tree representation to be built, but it is built and managed by code running in an application within the VM. With this design, reading or writing a memory location requires a logarithmic number of constant-time-provable instructions (instead of a single logarithmic-time provable instruction). The standard library provides a large flat memory abstraction for programmers' convenience.

An overview of the VM architecture is provided below.

Types.

The VM's optimized operation is fundamentally dependent on its type system. In one example, types include: a special null value None, booleans, characters (i.e., UTF-8 code points), 64-bit signed integers, 64-bit IEEE floating point numbers, byte arrays of length up to 32, and tuples. A tuple is an array of up to 8 values. The slots of a tuple may hold any value, including other tuples, recursively, so that a single tuple might contain an arbitrarily complex tree data structure. All values are immutable, and the implementation computes the hash of each tuple when it is created, so that the hash of any value can be (re-)computed in constant time. Note that Tuples, and by extension types, are a fundamental aspect of the VM design. Other non-crucial elements may change. For example, additional types may be added, or fewer types might be supported (such as only tuple and integer types).

VM State.

The state of a VM is organized hierarchically. This allows a hash of a VM's state to be computed in Merkle Tree fashion, and to be updated incrementally. The state hash can be updated efficiently as the machine's state changes, because the VM architecture ensures that instructions can only modify items near the root of the state tree and that each node of the state tree has a degree of no more than eight.

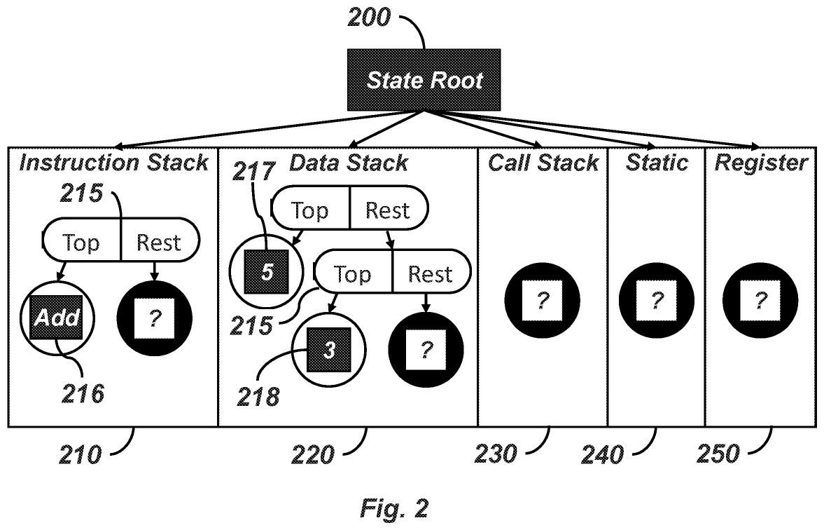

Referring now to FIG. 2, the state (200) of a VM contains the following elements: (i) an instruction stack (210), which encodes the current program counter and instructions (as described below); (ii) a data stack (220) of values (where a stack is represented as either None, representing an empty stack, or a 2-tuple (215) (top, rest) where top is the value on top of the stack and rest is the rest of the stack, in the same format); (iii) a call stack (230), used to store the return information for procedure calls; (iv) a static constant (240), which is immutable; and (v) a single mutable register (250) which holds one value.

When a VM is initialized, the instruction stack and static constant are typically initialized from an executable file; the data and call stacks are both empty; and the register is None. Note that because a single value can hold an arbitrary amount of data through recursive inclusion of tuples, the static constant can hold arbitrary amounts of constant data for use in a program, and the single register can be used to manage a mutable structure containing an arbitrary amount of data. Many programmers will choose to use a flat memory abstraction, e.g., one provided in a standard library, built on top of such a mutable structure.

Instructions.

The VM uses a stack-based architecture. VM instructions exist to manipulate the top of the stack, push values onto the stack, perform arithmetic and logic operations at the top of the stack, convert between types, compute the hash of a value, compute a sub-sequence of a byte array, and concatenate byte arrays. Control flow instructions include conditional jump, procedure call, and return. Instructions to operate on tuples include an instruction to a create new tuple filled with None, to read a slot from a tuple, and to copy a tuple while modifying the value of one slot. Finally, there are instructions to interact with other parties, which are described below.

The Instruction Stack.

Rather than using a conventional program counter, the disclosed system and method maintain an “instruction stack” which holds the instructions in the remainder of the program. Rather than advancing the program counter through a list of instructions, the VM pops the instruction stack to get the next instruction to execute. If the instruction stack is empty, the VM halts. Jump and procedure call instructions change the instruction stack, with procedure call storing the old instruction stack (pushing a copy of the instruction stack onto the call stack) so that it can be restored on procedure return.

This approach allows a one-step proof to use constant space and allows verification of the current instruction and the next instruction stack value in constant time. Note that a more conventional approach would keep an integer program counter, a linear array of instructions, and a pre-computed Merkle tree hash over the instruction array. Then a one-step proof would use a Merkle-tree proof to prove which instruction was under the current program counter. This would require logarithmic (in the number of instructions) space and logarithmic checking time for a one-step proof. By contrast the disclosed approach requires constant time and space.

Because a stack can be represented as a linked list, VM implementations will likely arrange all of the instructions in a program into a single linked list and maintaining the instruction stack value as a pointer into that linked list.

The Assembler and Loader.

The assembler takes a program written in an assembly language and translates it into an executable for this system/method. The assembler provides various forms of syntactic sugar that make programming somewhat easier, including control structures such as if/else statements, while loops, and closures. The assembler also supports inclusion of library files, such as those in the standard library.

The Standard Library.

The standard library is a set of useful facilities written in the disclosed system and method's assembly code. It contains about 3000 lines of assembly code, and supports useful data structures such as vectors of arbitrary size, key-value stores, an abstraction of a flat memory space on top of the register, and handling of time and incoming messages.

Interacting with Other VMs or Keys.

A VM interacts with other parties by sending and receiving messages. A message consists of a value, an amount of currency, and the identity of the sender and receiver. The “send” instruction takes values from the top of the stack and sends them as a message. If the message is not valid, for example because it tries to send more currency than the VM owns, the invalid message will be discarded rather than sent. A program uses the “inbox” instruction to copy the machine's message inbox to the stack. The standard library contains code to help manage incoming messages including tracking when new messages arrive and serving them one by one to the application.

The “balance” instruction allows a VM to determine how much currency it owns, and the “time” instruction allows a VM to get upper and lower bounds on the current time.

Preconditions, Assertions, and One-Step Proofs.

As described above, an assertion is a claim about an interval of a VM's execution. Each assertion is accompanied by a set of preconditions consisting of: a hash of the VM's state before the asserted execution, a hash of the VM's inbox contents, an optional lower bound on the VM's currency balance, and optional lower and upper bounds on the time (measured in block height). An assertion will be ignored as ineligible unless all of its preconditions hold. Parties may choose to store an ineligible assertion in the hope that it becomes eligible later.

In addition to preconditions, an assertion contains the following components: the hash of the machine state after the execution, the number of instructions executed, and the sequence of messages emitted by the VM.

The protocol may require a party to provide a one-step proof, which is a proof of correctness, assuming a set of preconditions, for an assertion covering the execution of a single instruction. A one-step proof must provide enough information, beyond the preconditions, to enable the Verifier to emulate the single instruction that will be executed. Because the state of the VM is organized as a Merkle Tree, and the starting state hash of the VM, which is just the root hash of that Merkle Tree, is given as a precondition, the proof need only expand out enough of the initial state Merkle tree to enable the Verifier to emulate execution of the single instruction, compute the unique assertion that results from executing that one instruction given the preconditions, and verify that it matches the claimed assertion.

A one-step proof expands out any parts of the state tree that are needed by the Verifier. For example, suppose that the instruction to be executed pops an item off the stack. Recall that the stack is represented as None for the empty stack, and otherwise as a 2-tuple (top, rest) where top is the top item on the stack and rest is the rest of the stack. In this example, if the stack hash is equal to the hash of None, then the Verifier will know that the stack is empty. Otherwise the prover (the party providing the one-step proof) will need to provide the hashes of top and rest, allowing the Verifier to check that those two hashes combine to yield the expected stack hash. Similarly, if the instruction is supposed to add two values, and the Verifier only has the hashes of the values, the proof must include the two values. In all cases the prover provides values that the Verifier will need to emulate the specified instruction, and the Verifier checks that the provided values are consistent with the hashes that the Verifier has already received. The VM emulator used by the prover can automatically determine which elements must be provided in the proof. FIG. 2 provides an illustration of the information revealed to a Verifier during a one-step proof of an add instruction—specifically, the black boxes (In FIG. 2, reference numbers 216 [add], 217 [5], 218 [3]) are values that are sent by the asserter to the verifier in the one-step proof.

Messages and the Inbox.

Messages can be sent to a VM in two ways: a key can send a message by putting a special message delivery transaction on the blockchain; and another VM can send a message by using the send instruction. A message logically has four fields: data, which is an VM value (marshaled into a byte array on the blockchain); a non-negative amount of currency, which is to be transferred from the sender to the receiver; and the identities of the sender and receiver of the message.

Every VM has an inbox whose hash is tracked by the Verifier. An empty inbox is represented as the VM value None. A new message M can be appended to a VM's inbox by setting the inbox to a 2-tuple (prev, M), where prev is the previous state of the inbox. A VM can execute the inbox instruction which pushes the current value of the VM's inbox onto the VM's stack.

A VM's validators track the state of its inbox, but the Verifier only needs to track the hash of the inbox, because that is all that will be needed to verify a one-step proof of the VM receiving the inbox contents. If the VM later processes the inbox contents, and a one-step proof of some step of that processing is needed, the validators will be able to provide any values needed.

Because the inbox instruction gives the VM an inbox state that may be a linked list of multiple messages, programmers may wish to buffer those messages inside the VM to provide an abstraction of receiving one message at a time. The standard library provides code to do this as well as track when new messages have arrived in the inbox.

Lifecycle of a VM

A disclosed VM may be configured by machine-readable instructions to run on one or more processors. For example, in some embodiments the disclosed VM is emulated by a single real processor. Broadly, the disclosed VM is created using a special transaction, which specifies the initial state hash of the VM, a list of validators for the VM, and some parameters, which are stored by the VM. As described below, the state hash represents a cryptographic commitment to the VM's state (i.e., its code and initial data). Any number of VMs can exist at the same time, typically with different validators.

Once a VM is created, validators can take action to cause that VM's state to change. The disclosed protocol provides an any-trust guarantee: any one honest validator can force the VM's state changes to be consistent with the VM's code and state, that is, to be a valid execution.

An assertion states that if certain preconditions hold, the VM's state will change in a certain way. An assertion about a VM is said to be eligible if (1) the assertion's preconditions hold, (2) the VM is not in a halted state, and (3) the assertion does not spend more funds than the VM owns. The assertion contains the hash of the VM's new state, and a set of actions taken by the VM, such as sending messages or currency.

Unanimous assertions are signed by all validators of that VM. If a unanimous assertion is eligible, it is immediately accepted by the Verifier as the new state of the VM.

Disputable assertions are not signed by all validators. Preferably, disputed assertions are signed by only a single validator, and that validator attaches a currency deposit to the assertion. If a disputable assertion is eligible, the assertion is published by the Verifier as pending. If a time-out period passes without any other validator challenging the pending assertion, the assertion is accepted by the Verifier and the asserter gets its deposit back. If another validator challenges the pending assertion, the challenger puts down a currency deposit, and the two validators engage in a dissection protocol, which determines which of them is lying. If multiple validators challenge a pending assertion, the validators engage in a dissection protocol appropriate for the number of validators involved. An assertion may be dissected into any number of smaller assertions. In some embodiments, the number of smaller assertions is 10 or less. In some embodiments, the number of smaller assertions is 5 or less.

A liar will lose its deposit. A VM continues to advance its state as described above, until the VM reaches a halted state. At this point no further state changes are possible, and the Verifier and validators can forget about the VM.

The Verifier

Recall that the Verifier is the mechanism, which may be a distributed protocol with multiple participants, that verifies transactions and publishes verified transactions. Thus, the verifier is typically one or more processors configured by machine-readable instructions. In addition to storing a few parameters about each VM such as a list of its validators, the Verifier tracks three pieces of information about each VM that change over time: the hash of the VM's state, the amount of currency held by the VM, and the hash of the VM's inbox which holds messages sent to the VM. The state of a VM is advanced, corresponding to execution of the VM's program, by the Verifier's acceptance of assertions made by the VM's validators.

The Verifier employs a dissection protocol to narrow a disagreement about what the VM will do to an execution of a single instruction, which requires receiving a proof of the execution of a single instruction and verifying the proof.

More specifically, the dissection protocol begins when one validator has made a disputable assertion and at least one other validator has challenged that assertion.

If a validator challenges an assertion, the challenger must escrow a deposit. Now the asserter and the challenger(s) engage in a game, via a series of blockchain transactions made by the asserter and challenger(s) (e.g., using a public protocol), to determine who is incorrect. Any party who wins the game will recover its own deposit and will take up to half of the losing party's deposit (i.e., half of the deposit divided by the number of winners). The other half of the loser's deposit will go to the Verifier, as compensation for the work required to referee the game.

The game is played in alternating steps. After a challenge is lodged, the asserter is given a pre-specified time interval to dissect its previous assertion. As an example, that uses a bisection, if the previous assertion involved N steps of execution in the VM, then the two new assertions must involve [N/2] and [N/2] steps, respectively, and the two assertions must combine to be equivalent to the previous assertion. If no valid dissection is offered within the time limit, the challenger wins the game.

After a dissection is offered, the challenger(s) must challenge one of the new assertions, which they can choose, within a pre-specified time interval.

The players in the game (the validators) alternate moves. At each step, a player must move within a specified time interval, or lose the game. Each move requires the player making the move to make a small additional deposit, which is added to the stakes of the game.

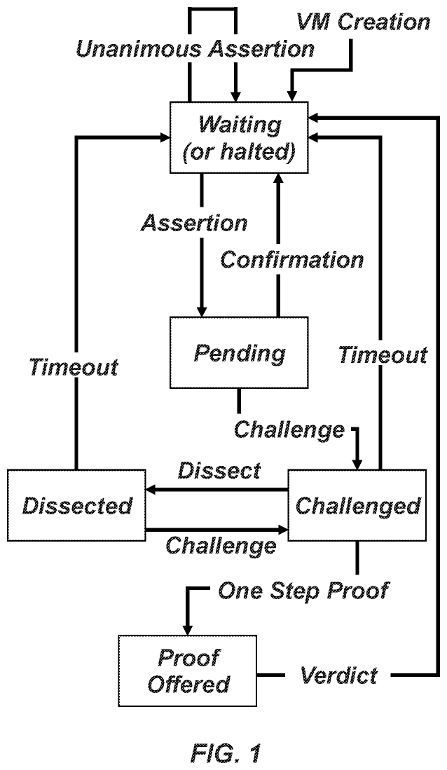

After a logarithmic number of dissections, the challenger will challenge an assertion that covers a single step of execution. At this point the asserter must offer a one-step proof, which establishes that in the asserted initial state, and assuming the preconditions, executing a single instruction in the VM will reach the asserted final state and take the asserted publicly visible actions, if any. This one-step proof is verified by the Verifier. The Verifier only needs to check the facial validity of the moves, for example, checking that a bisection of an assertion into two half-sized assertions is valid in the sense that the two resulting assertions do indeed compose to yield the original assertion. See FIG. 1 for an overview of the state machine implementing this protocol.

The asserter wins if they provide a correct proof; otherwise the challenger(s) win. Each winner gets their deposit back and also takes their percentage of half of the loser's deposit (that is, if one challenger wins, the challenger gets the entire half of the loser's deposit. If two challengers win, they each get 25% of the loser's deposit (50%/2 winners). The other half of the loser's deposit goes to the Verifier.

An assertion that is challenged cannot be accepted by the Verifier, even if the asserter wins the challenge game. Instead, an assertion is “orphaned” when it is challenged. After the challenge game is over, the asserter has the option of resubmitting the same assertion, although this would obviously be foolish if the assertion is incorrect.

The protocol design ensures that a single honest validator can always prevent an incorrect assertion from being accepted, by challenging it. (If somebody else challenges the assertion before the honest validator can do so, the assertion is still prevented from being accepted, even if the challenger is malicious.) An honest validator can also ensure that the VM makes progress, by making disputable assertions, except that a malicious validator can delay progress for the duration of one dissection protocol at the cost of half of a deposit, by forcing a dissection protocol that it knows it will lose.

The Protocol

The protocol governs the public process that manages and advances the public state of the overall system and each VM. The disclosed system and method use a simple cryptocurrency design, augmented with features to allow the creation and use of Virtual Machines (VMs), which can embody arbitrary functionality. VMs are programs running on the disclosed Virtual Machine Architecture, which is described herein.

The disclosed protocol recognizes two kinds of actors: keys and VMs. A key is identified by the cryptographic hash of a public key, and the actor is deemed to have taken an action if that action is signed by the corresponding private key. The other kind of actor is a VM, which takes actions by executing code. Any actor can own currency. The disclosed system and method track how much currency is owned by each actor.

A VM is created using a special transaction type. The VM-creation transaction specifies a cryptographic hash of the initial state of the VM, along with some parameters of the VM, such as the length of the challenge period, the amounts of various payments and deposits that parties will make as the protocol executes further, as well as a list of the VM's validators.

For each VM, the Verifier tracks the hashed state of that VM, along with the amount of currency held by the VM, and a hash of its inbox. A VM's state can be changed via assertions about the VM's execution, which specify (1) the number of instructions executed by the VM, (2) the hash of the VM's state after the execution, and (3) any actions taken by the VM such as making payments. Further, the assertion states a set of preconditions that must be true before the assertion which specify (1) the hash of the VM's state before the execution, (2) an upper and lower bound on the time that the assertion is included in a block, (3) a lower bound on the balance held by the VM, and (4) a hash of the VM's inbox. The rules of the disclosed system and method dictate under which conditions an assertion is accepted. If an assertion is accepted, then the VM is deemed to have changed its state, and taken publicly visible actions, as specified by the assertion.

In the simplest case, an assertion is signed by all of the VM's validators. In this case, the assertion is accepted by the verifiers if the assertion is eligible, that is, if (1) the assertion's precondition matches the current state of the VM, (2) the VM is not in a halted state, and (3) the VM has enough funds to make any payments specified by the assertion. Unanimous assertions are relatively cheap for verifiers to verify, requiring only checking eligibility and verifying the validators' signatures, so they require a small transaction fee.

In a more complicated case, an assertion is signed by just one of the validators—a “disputable assertion.” Along with the assertion, the asserting validator must escrow a deposit. Such a disputable assertion is not accepted immediately, but rather, if it is eligible, it is published as pending, and other validators are given a pre-specified time interval in which they can challenge the assertion. (The number of steps allowed in a disputable assertion is limited to a maximum value that is set as a parameter when the VM is created, to ensure that other validators have enough time to emulate the declared number of steps of execution before the challenge interval expires.) If no challenge occurs during the interval, then the assertion is accepted, the VM is deemed to have made the asserted state change and taken the asserted actions, and the asserting validator gets its deposit back.

Key Assumptions and Tradeoffs

The disclosed allows the party who creates a VM to specify that VM's code, initial data, and set of validators. The Verifier ensures that a VM cannot create currency but can only spend currency that was sent to it. Thus, a party who does not know a VM's state or who does not like a VM's code, initial data, or set of validators can safely ignore that VM. It is assumed that parties will only pay attention to a VM if they agree that the VM was initialized correctly and they have some stake in its correct execution. Any party is free to create a VM that is obscure or unfair; and other parties are free to ignore it.

By the disclosed system and method's any-trust assumption, parties should only rely on the correct behavior of a VM if they trust at least one of the VM's validators. One way to have a validator you trust is to serve as a validator yourself. We also expect that a mature ecosystem would include validator-as-a-service businesses that have incentives to maintain a reputation for honesty and may additionally accept legal liability for failure to carry out an honest validator's duties.

One key assumption that the disclosed approach makes is that a validator will be able to send a challenge or response to the Verifier within the specified time window. In a blockchain setting, this means the ability get a transaction included in the blockchain within that time. While critical, this assumption is standard in cryptocurrencies, and risk can be mitigated by extending the challenge interval (which is a configurable parameter of each VM).

Two factors help to reduce the attractiveness of denial of service attacks against honest validators. First, if a DoS attacker cannot be certain of preventing an honest validator from submitting a challenge but can only reduce the probability of a challenge top, the risk of incurring a penalty may still be enough to deter a false assertion, especially if the deposit amount is increased. Second, because each validator is identified only by a public key, a validator can use replication to improve its availability, including the use of “undercover” replicas whose existence or location is not known to the attacker in advance.

Lastly, a motivated malicious validator can indefinitely stall a VM by continuously challenging all assertions about its behavior. The attacker will lose at least half of every deposit, and each such loss will delay the progress of the VM only for the time required to run the dissection protocol once. We assume that the creators of a VM will set the deposit amount for the VM to be large enough to deter this attack.

Benefits

Scalability.

Perhaps the key feature of the disclosed approach is its scalability. Validators can execute a machine indefinitely, paying only negligible transaction fees that are small and independent of the complexity of the code they are running. If participants follow incentives, all assertions should be unanimous and disputes should never occur, but even if a dispute does occur, the Verifier can efficiently resolve it at little cost to honest parties (but substantial cost to a dishonest party).

Privacy.

The disclosed approach's model is well-suited for private smart contracts. Absent a dispute, no internal state of a VM is revealed to the Verifier. Further, disputes should not occur if all parties execute the protocol according to their incentives. Even in the case of a dispute, the Verifier is only given information about a single step of the machine's execution, but the vast majority of the machine's state remains opaque to the Verifier. Using certain extensions (discussed below), this leak can be eliminated by doing the one step verification in a privacy-preserving manner. The disclosed approach's privacy is no coincidence, but rather a direct result of its model. Since the disclosed Verifier (e.g., the miners in a Nakamoto consensus model) do not run a VM's code, they do not need to see it. By contrast, in Ethereum, or any system that attempts to achieve “global correctness,” all code and state has to be public so that anyone can verify it, and this model is fundamentally at odds with private execution.

Flexibility.

Unanimous assertions provide a great deal of flexibility as validators can choose to reset a machine to any state that they wish and take any actions that they want (provided that the machine has the funds)—even if they are invalid by the machine's code. This requires unanimous agreement by the validators, so if any one validator is honest, this will only be done when the result is one that an honest validator would accept—such as winding down a VM that has gotten into a bad state due to a software bug.

Extensions

Below are extensions to the disclosed design that may prove useful, particularly when the Verifier is implemented as a public blockchain.

Off-Chain Progress.

The disclosed system and method allow VMs to perform orders of magnitude more computation than existing systems at the same on-chain cost. However, usage of VMs frequently depends on communication between a VM's validators and the VM itself. The disclosed system and method are compatible with state-channel and sidechain techniques, and there are several constructions that allow validators to communicate with a VM and unanimously advance a VM's state off-chain.

Zero Knowledge One Step Proofs.

While the disclosed has good privacy properties, there is one scenario in which a small privacy leak is possible. A validator submitting a one-step proof will be forced to reveal some of the state as part of the proof. While only a small portion of the state will be revealed for each challenge, and only if the validators fail to agree on a unanimous assertion, this can potentially be sensitive data.

One option is to implement the one-step proof as a zero-knowledge protocol using Bulletproofs (see, e.g., Bünz et al., “Bulletproofs: Efficient range proofs for confidential transactions”). To do so will require encoding a one-step VM transition as an arithmetic circuit and proving that the transition is valid. While another option is to use a Succinct Non-interactive ARgument of Knowledge (SNARK), Bulletproofs have the benefit that they do not require a trusted setup. Although verification time for Bulletproofs is linear in the circuit, considering that a one-step transition circuit will be small, and that one-step proofs will be infrequent events, this should not be a problem in practice.

While zero-knowledge proofs can in theory be used to prove the correctness of the entire state transition (and not just a single step), doing this for complex computations is not feasible with current tools. Combining the challenge and bisection protocol with a zero-knowledge proof only at the last step allows us to simultaneously achieve scalability and full privacy. This takes advantage of the fact that the disclosed VM is designed to simplify one-step proofs.

Reading the Blockchain.

In preferred embodiments, the VMs do not have the ability to directly read the blockchain.

If launched as a public blockchain, one could easily extend the VM instruction set to allow a VM to read the blockchain directly. To do so, we would create a canonical encoding of a block as a tuple, with one field of that tuple containing the tuple representing the previous block in the blockchain. This would allow a VM that had the tuple for the current block to read earlier blocks. The precondition of an assertion would specify a recent block height, and the VM would have a special instruction that pushes the associated block tuple to the stack. In order to be able to verify a one-step proof of this instruction, the Verifier just needs to keep track of the tuple hash of each block (just a single hash per block).

Reading the blockchain does not require putting lots of data on a VM's data stack. A blockchain read consists of putting just the top-level tuple of the specified block on the stack. To read deeper into the blockchain, this tuple can be lazily expanded, providing the VM with just the data that it needs to read the desired location. Note that reading the blockchain in this manner supports oblivious reads compatible with zero-knowledge proofs, as the Verifier does not need to know what position (if any) in the blockchain is being read. The Verifier need only verify the top-level tuple hash, which is the hash of a recent block. If the tuple was expanded to read deeper into the blockchain, this all happens inside application code and the location of the read will not be published on-chain. In this manner, blockchain reads are fully compatible with zero-knowledge one-step proofs. In particular, the Verifier would always provide the specified block tuple hash as an input to the zero-knowledge proof. If indeed the one-step proof is on a read-blockchain instruction, the proof would verify that the correct hash was put on the stack. The zero knowledge proof would not leak information as to whether the blockchain was actually read (as the block hash is always an input to the proof even if no read occurred) or where on the blockchain a read occurred (since the current block tuple could have been expanded inside application code to read anywhere in the blockchain).

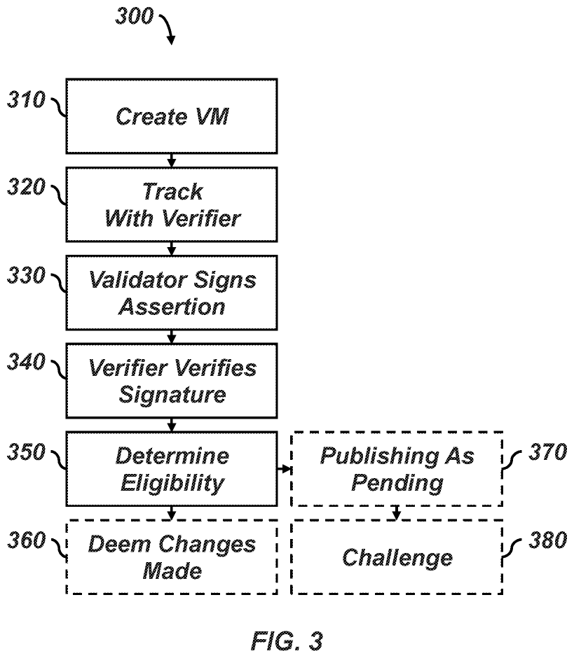

One embodiment of the disclosed method can be seen in reference to FIG. 3. There, the method (300) includes creating a virtual machine (310) that specifies an initial hash of the VM's state, a list of validators for the VM, and a length of a challenge period, where the hash of the VM's state represents a cryptographic commitment to the VM's code and initial data.

Optionally, creating the VM also includes specifies at least one additional parameter, such as an amount of a payment or deposit that a party will make as the protocol executes further.

A verifier then tracks (320) only a hash of the VM's current state, currency held by the VM, and a hash of the VM's inbox which holds messages sent to the VM.

At least one validator then must sign an assertion (330) about the VM's execution, where the assertion specifies at least how many instructions are to be executed by the VM, a hash of the VM's state after execution, and a set of preconditions that includes the hash of the VM's state before the execution, and a hash of the VM's inbox. Optionally, the assertion can include an action to be taken by the VM, such as making a payment.

The method (300) then continues with a verifier then verifying the at least one validator's signature (340). The method continues by determining if the signed assertion is eligible (350). A signed assertion is only eligible if the signed assertion's preconditions match the current state of the VM (which may include a state of the external world, e.g., the current time), the VM is not in a halted state, and the VM has enough funds to make any payment specified by the signed assertion.

Optionally, the method (300) may include deeming the VM to have made the asserted state change (360) and taken the asserted actions of a signed assertion if the signatures of each of the plurality of validators are verified.

Optionally, the method (300) may include publishing an eligible signed assertion as pending (370) if not all of the plurality of validators signs the signed assertion; having the asserting validator escrow a deposit (not shown); and entering into the challenge period (380). In some embodiments, the asserting validator gets its deposit back if no challenge occurs during the challenge period. In some embodiments, a validator can challenge the asserting validator's signed assertion during the challenge period by escrowing a deposit and participating in a protocol based on recursive division of the signed assertion that is refereed by the verifier. In some embodiments, the verifier only checks the facial validity of actions performed during the protocol. In some embodiments, checking the facial validity of actions includes receiving a plurality of small assertions and verifying that the plurality of small assertions combine to yield the signed assertion.

In situations where a first party (e.g., a first validator) is deemed the winner of the protocol and a second party (e.g., a second validator) is deemed the loser of the protocol, the winner of the protocol recovers its own deposit and a portion of the losing party's deposit, and the loser of the protocol loses its deposit.

Optionally, each validator escrows an initial deposit when a new VM is created, and the initial deposit is deemed to cover each of that validator's assertions and challenges over the life of the new VM.

Implementation and Benchmarks

In order to refine and evaluate the system and method, a full implementation of the system was produced. This includes code to represent all parties involved: a centralized Verifier, a VM, an honest validator, and a key-based actor. These parties are fully capable of performing all parts of the disclosed protocol. This implementation comprises about 6800 lines of Go code, including about 3400 lines for the VM emulator, 1350 lines for the assembler and loader, 650 lines for the honest validator, 550 lines for the Verifier, and the remainder for various shared code.

In order to ease the coding of more powerful smart contract VMs, a standard library was implemented, which contains about 3000 lines of assembly code, supporting useful data structures such as large tuples, key-value stores, queues, and character strings; and utilities for handling messages, currency, and time. The power and versatility of this implementation can be demonstrated by implementing two smart contracts.

Escrow Contract.

A first example is a simple escrow contract. The escrow code first waits for a message containing the identities of three parties (Alice, Bob, and Trent) and an integer deadline, along with some amount of currency that the VM will hold. The VM then waits for a message from Trent, ignoring messages that arrive from anybody else. If the message from Trent contains an even integer, the VM sends the currency to Alice and halts. If the message from Trent contains something else, the VM sends the currency to Bob and halts. If the current time exceeds the deadline, the VM sends half of the currency to Alice, the remaining currency to Bob, and then halts. This requires 59 lines of assembly code, which makes significant use of the standard library. The executable file produced by the assembler contains 4016 instructions.

Executing the contract requires 5 total transactions to be added to the blockchain. The initial create VM transaction is 309 bytes. After that a 310-byte message is sent to the VM communicating the identities of the parties involved and the deadline and giving currency to the VM. Next, Trent indicates his verdict by sending a 178-byte message to the VM.

Next, the VM must be executed to actually cause the payouts. First a 350-byte assertion is broadcast, asserting the execution of 2897 VM instructions, leaving the VM in the halted state. Next after the challenge window has passed, a confirmation transaction of 113 bytes is broadcast confirming and accepting the asserted execution. The entire process requires a total of 1,260 bytes to be written to the blockchain.

Iterated Hashing.

A second example where the disclosed performs well is the efficiency with which it can carry out VM computation. To demonstrate this, the throughput of a VM which performs iterative SHA-256 hashing was measured. The code for this VM is an infinite loop where the VM hashes 1000 times and then jumps back to the beginning. The VM code makes use of the VM's hash instruction, which is implemented in native code.

Operating performance of this VM was evaluated on an early 2013 Apple MacBook Pro, 2.7 GHz Intel Core i7. As a baseline, using native code on the same machine, we were able to perform 1,700,000 hashes per second. Running the VM continuously we were able to advance the VM by 970,000 hashes per second. Our implementation was able to achieve over half of the raw performance of native code. This stands in comparison to Ethereum, which is capable of processing a total of approximately 1600 hashes per second (limited by Ethereum's global gas limit, which is required due to the Verifier's Dilemma).

The disclosed system's performance advantage extends further. While the current limit on execution inside a single VM was demonstrated, the Verifier is capable of handling large numbers of VMs simultaneously. Instantiating many copies of the Iterated Hashing VM, the Verifier node running on the machine was found to be capable of processing over 5000 disputable assertions per second. This brings the total possible network throughput up to over 4 billion hashes per second, compared to 1600 for Ethereum.

Thus, the disclosed system and method are a new platform for smart contracts with significantly better scalability and privacy than previous solutions. This solution is consensus agnostic and is pluggable with any existing mechanism for achieving consensus over a blockchain. The system is elegant in its simplicity, and its straightforward and intuitive incentive structure avoids many pitfalls that affect other proposed systems.

The system creates incentives for parties to agree off-chain on what smart contract VMs will do, and even if parties act contrary to incentives the cost to miners or other verifiers is low. The system additionally uses a virtual machine architecture that is custom-designed to reduce the cost of on-chain dispute resolution. Moving the enforcement of VM behavior mostly off-chain, and reducing the cost of on-chain resolution, leads to the system's advantages in scalability and privacy.

Event Chains

Arbitrum provides a smart contract system where computation and storage are both handled off-chain, providing Arbitrum with much better scalability than competing systems. However, providing input to a VM (by sending a message to it) requires on-chain action, creating a potential bottleneck for VMs that require frequent input.

The Arbitrum protocol can be naturally extended with an event chain construct to allow inputs to be provided to a VM with minimal on-chain activity. This appendix describes one approach to extending the initial Arbitrum design to support event chains.

Overview The validators of a VM can work together unanimously to construct an event chain: a chain of events, separate from the main chain, for that VM. Events include the arrival of a message from a validator to the VM, and execution of code by the VM.

A new event is added to an event chain when the validators unanimously sign a new event chain assertion, which contains hashes of the VM′ state and the VM's inbox, along with a sequence number.

At any time, the latest event chain assertion can be written to the main chain. There is then a challenge period during which other validators can supersede the initial event chain assertion by posting an event chain assertion from the same chain that has a higher sequence number.

When an event chain assertion is accepted by the main chain, this ends the event chain. The validators are then free to create a new event chain.

Protocol Details We introduce a new type of assertion, a event chain assertion as well as the notion of event chain events.

An Arbitrum event chain consists of a sequence of events. Each event contains the hash of the previous event, so that the hash of the last event in the chain serves as a commitment to the full contents of the chain. Every event in an event chain for a VM must be signed unanimously by all of that VM's validators.

There are two types of event chain actions:
Deliver Message: This event contains a new message to add to the VM's inbox. These incoming messages can contain data but not currency. Note that the messages specify their sender. Validators are responsible for assuring the correctness of a message's sender and its content (by verifying the sender's digital signature).
Execute: This event specifies an assertion of VM execution, starting from state resulting from the previous execute event (or the state at the start of the event chain if this is the first execute event in the chain). All messages delivered to the VM within this event chain should be in the inbox for this event. No messages delivered on-chain since the event chain was opened are visible within the event chain.

Validators can include new events in an event chain by signing a new event chain assertion which includes a hash of the latest event in the chain. A VM's validators can begin a new event chain without any on-chain actions. There is no special assertion to begin an event chain; validators can transition to an event chain and broadcast an event chain assertion to the chain at any point.

An event chain assertion typically contains the following parts:
a sequence number of the latest event on the event chain;
the hash of the latest event on the event chain (implicitly a hash of all events in the chain);
a reference to the latest on-chain accepted assertion for the VM;
the VM's state hash;
the hash of the VM's inbox; and
the sequence of messages sent by the VM during the entire event chain.

Similarly to unanimous assertions, event chain assertions must be signed by all validators of a VM.

An event chain assertion can be published on the main chain at any time, but only if the latest on-chain accepted assertion listed in the event chain assertion is still the most recent on-chain accepted assertion for the VM, and only if the event chain assertion does not overspend the VM's funds. This implies that if a new assertion is accepted on-chain during the operation of an event chain, this will orphan the event chain.

Finality.

Event chains allow VMs to function with instant finality. This means that as soon as all validators have signed a given event chain assertion, any validator can guarantee that all the events in the chain will eventually be recorded on the main chain.

This property is achieved by ensuring that a valid event chain assertion can never be invalidated except by unanimous action of the validators. A valid event chain assertion can only be invalidated by modifying the latest on-chain assertion, and the following rules ensure that this cannot happen.
If a disputable assertion is published on-chain, it can be superseded by an event chain assertion, during the period when the system is waiting for challenges to the disputable assertion. If this happens, the asserter of the disputable assertion gets their deposit back. (But if a challenge to the disputable assertion has already started, the challenge is still resolved normally, and the asserter might lose its deposit as a result.)
When an event chain assertion is published on-chain, there is a challenge period, during which any party can publish a valid assertion with the same starting point and a higher sequence number, which will supersede the original assertion. Thus, any validator can ensure that the latest event chain assertion is accepted.
If a unanimous assertion is published to the chain while a event chain is operating, the event chain will be invalidated. However, any one validator can ensure that this will not happen, by refusing to sign a unanimous on-chain assertion while the event chain is being built.

Inbox Updates.

While an event chain is operating, messages to the VM can arrive on-chain in the normal way. These messages are queued, and they are appended to the end of the inbox when the event chain assertion is published. In other words, when a event chain assertion is accepted, the inbox now contains the following, in order: messages received before the event chain started; messages received on the event chain; messages received on the main chain while the event chain was being built. Logically, the messages arriving on the main chain are not “seen” by the VM until after the event chain is committed back onto the main chain.

This message-handling method requires a minor change to the representation of a VM's inbox. Previously, the inbox was a sequence of messages. Now it will be a sequence of sequences of messages.

The Verifier will now need to keep what amounts to two (hashes of) message sequences for each VM: the main long-term inbox, and a “buffer” sequence of messages that have arrived since the last accepted assertion. The buffer sequence is appended into the main inbox only when an assertion is made. For a unanimous or disputable assertion, the buffer is appended to the main in-box before the VM starts executing (and the state of the buffer after this appending occurs is a precondition to the assertion). For an event chain assertion, the buffer is appended to the main inbox as described above-logically, after the execution on the event chain, so an event chain assertion need not have a precondition about the buffer.

Event Chains and Auditability.

In Arbitrum, there may be parties interested in a VM who are not themselves validators. Auditability of Arbitrum VMs means that a party who knows the initial state of a VM, and who observes on-chain events pertaining to that VM, can “follow along” and keep track of the VM's state over time. This implies that if the VM deviates from correct behavior due to misbehavior by a conspiracy of validators, an auditing party will be able to produce proof that misbehavior occurred.

Arbitrum event chains are similar to the state channels described in previous literature. That literature conventionally assumes that all participants in a state channel act as validators (using our terminology) of that channel. All participants of a channel must sign all transactions and thus they are all guaranteed to know exactly what happens in the channel. There was no need for auditability of the state channel in this context since it was assumed that all participants were themselves validators who signed all transactions.

Arbitrum event chains are designed to preserve a slightly weaker notion of auditability: a party who knows the state of a VM before an event chain can infer the state of the VM after the event chain, provided that at least one validator is willing to reveal the contents of the event chain to that party. This implies that any validator will be able to prove whether the VM executed correctly on an event chain, but no proof of correct or incorrect behavior will be possible in the case where all validators refuse to provide information about what happened on the event chain.

Those skilled in the art will recognize or be able to ascertain using no more than routine experimentation many equivalents to the specific embodiments of the invention described herein. Such equivalents are intended to be encompassed by the following claims.

What is claimed:

1. A method for implementing more efficient, scalable, private smart contracts, comprising the steps of:
(a) creating a virtual machine (VM) that specifies an initial hash of the VM's state, a list containing a plurality of validators for the VM, and a length of a challenge period, where the hash of the VM's state represents a cryptographic commitment to the VM's code and initial data;
(b) tracking, with a verifier, only a hash of the VM's current state, currency held by the VM, and a hash of the VM's inbox which holds messages sent to the VM;
(c) allowing at least one of the plurality of validators to sign an assertion about the VM's execution, the assertion specifying how many instructions are to be executed by the VM, a hash of the VM's state after execution, and a set of preconditions that includes:
(i) the hash of the VM's state before the execution; and
(ii) a hash of the VM's inbox;
(d) verifying the at least one of the plurality of validator's signature; and
(e) determining if signed assertion is eligible, where a signed assertion is only eligible if the signed assertion's preconditions match the current state of the VM, the VM is not in a halted state, and the VM has enough funds to make any payment specified by the signed assertion.

2. The method according to claim 1, further comprising deeming the VM to have made the asserted state change and taken the asserted actions of a signed assertion if the signatures of each of the plurality of validators are verified.

3. The method according to claim 1, further comprising publishing an eligible signed assertion as pending if not all of the plurality of validators signs the signed assertion; having the asserting validator escrow a deposit; and entering into the challenge period.

4. The method according to claim 3, wherein the asserting validator gets its deposit back if no challenge occurs during the challenge period.

5. The method according to claim 3, further comprising having a validator challenge the asserting validator's signed assertion during the challenge period by escrowing a deposit and participating in a protocol based on recursive division of the signed assertion that is refereed by the verifier.

6. The method according to claim 5, where the verifier only checks the facial validity of actions performed during the protocol.

7. The method according to claim 5, wherein a first party is deemed the winner of the protocol, a second party is deemed the loser of the protocol, the winner of the protocol recovers its own deposit and a portion of the losing party's deposit, and the loser of the protocol loses its deposit.

8. The method according to claim 1, wherein each validator escrows an initial deposit when a new VM is created, and the initial deposit is deemed to cover each of that validator's assertions and challenges over the life of the new VM.

9. The method according to claim 1, wherein creating the VM further includes specifies at least one additional parameter.

10. The method according to claim 9, wherein the parameter is an amount of a payment or deposit that a party will make as the protocol executes further.

11. The method according to claim 1, wherein the assertion further includes an action to be taken by the VM.

12. The method according to claim 11, wherein the action is making a payment.

13. A system configured for implementing more efficient, scalable, private smart contracts, the system comprising:
one or more processors configured by machine-readable instructions to:
(a) create a virtual machine (VM) that specifies an initial hash of the VM's state, a list containing a plurality of validators for the VM, and a length of a challenge period, where the hash of the VM's state represents a cryptographic commitment to the VM's code and initial data;
(b) track, with a verifier, only a hash of the VM's current state, currency held by the VM, and a hash of the VM's inbox which holds messages sent to the VM;
(c) receive a signed assertion about the VM's execution from a validator, the signed assertion specifying how many instructions are to be executed by the VM, a hash of the VM's state after execution, and a set of preconditions that includes:
(i) the hash of the VM's state before the execution; and
(ii) a hash of the VM's inbox;
(d) verify the at least one validator's signature;
(e) determine if the signed assertion is eligible, where a signed assertion is only eligible if the signed assertion's preconditions match the current state of the VM, the VM is not in a halted state, and the VM has enough funds to make any payment specified by the signed assertion;
(f) deem the VM to have made the asserted state change and taken the asserted actions of an eligible signed assertion if each of the signatures of the plurality of validators are verified;
(g) publish an eligible signed assertion as pending if not all of the plurality of validators signs the signed assertion, enter into a challenge period, and require the asserting validator escrow a deposit;
(h) send the asserting validator its deposit back if no challenge occurs during the challenge period and deem the VM to have made the asserted state change and taken the asserted actions of the eligible signed assertion if the signatures of the at least one validator's signature are verified; and
(i) receive a deposit from a challenging validator, verify the facial validity of actions performed during a protocol based on recursive division of the signed assertion, determine a first party to be the winner of the protocol and a second party to be the loser of the protocol, and send the winner of the game its own deposit and a portion of the losing party's deposit.

14. The system according to claim 13, wherein instructions to verify the facial validity of actions includes instructions to receive a plurality of small assertions and verify that the plurality of small assertions combine to yield the signed assertion.

15. The system according to claim 13, wherein creating the VM further includes specifies at least one additional parameter.

16. The system according to claim 15, wherein the parameter is an amount of a payment or deposit that a party will make as the protocol executes further.

17. The system according to claim 13, wherein the assertion further includes an action to be taken by the VM.

18. The system according to claim 17, wherein the action is making a payment.

19. A non-transitory computer readable medium storing software for handling proofs efficiently, the software comprising:
executable code that creates a virtual machine associated with a data storage, wherein the virtual machine is configured to have memory organized as a set of blocks having a fixed upper size limit, and further configured to allow blocks to reference other blocks only in an acyclic fashion.

20. The non-transitory readable medium according to claim 19, wherein the virtual machine is configured such that blocks are immutable.

21. The non-transitory readable medium according to claim 19, wherein the virtual machine is further configured to emit a proof that is checkable by some external party.

22. A non-transitory computer readable medium storing software for handling proofs efficiently, the software comprising:
executable code that creates a virtual machine associated with a data storage, wherein the virtual machine is configured to have instructions organized using a stack data structure whereby each instruction is removed from stack when executed.

23. The non-transitory readable medium according to claim 22, wherein the virtual machine is further configured to replace a stack of instructions with a new stack of instructions, save values to the data storage, restore values from the data storage, or some combination thereof.

24. The non-transitory readable medium according to claim 22, wherein the virtual machine is further configured to emit a proof that is checkable by some external party.

25. A virtual machine (VM) comprising:
one or more processors configured by machine-readable instructions to:
store an initial hash of the VM's state;
store a list of validators for the VM; and
store a length of a challenge period;
wherein the hash of the VM's state represents a cryptographic commitment to the VM's code and initial data;
wherein the one or more processors are further configured to send a signal comprising a hash of the VM's current state, currency held by the VM, and a hash of the VM's inbox which holds messages sent to the VM; and
wherein the one or more processors are further configured to receive a signed assertion about the VM's execution from a validator, the signed assertion specifying how many instructions are to be executed by the VM, a hash of the VM's state after execution, and a set of preconditions that includes the hash of the VM's state before the execution, and a hash of the VM's inbox.

26. A verifier, comprising:
one or more processors configured by machine-readable instructions to:
track the hash of a state of a virtual machine (VM);
employ a dissection protocol to narrow a disagreement about what the VM will do to an execution of a single instruction;
receive a proof of the execution of a single instruction; and
verify the proof.
